(19) United States
(12) Patent Application Publication
(10) Pub. No.: US 2021/0336311 A1
(43) Pub. Date: Oct. 28, 2021

(54) MOISTURE ABSORBING AND HYDROFLUORIC ACID SCAVENGING MEMBRANES COMPRISING ARAMID NANOFIBERS

(71) Applicant: SOTERIA BATTERY INNOVATION GROUP, INC., Greenville, SC (US)

(72) Inventors: Siu On Tung, Ann Arbor, MI (US); John Philip Hennessy, Ann Arbor, MI (US); Steven Nathan Kaganove, Ann Arbor, MI (US); Nicholas Alexander Kotov, Ann Arbor, MI (US); Dennis William Townsend, Ann Arbor, MI (US); Long Qian, Ann Arbor, MI (US)

(21) Appl. No.: 17/221,766

(22) Filed: Apr. 2, 2021

Related U.S. Application Data
(60) Provisional application No. 63/004,631, filed on Apr. 3, 2020.

(51) Int. Cl. H01M 50/489; H01M 50/44; H01M 50/423

(52) U.S. Cl. CPC H01M 50/489; H01M 50/423; H01M 50/44

(57) ABSTRACT

The application provides nanoporous separator membranes, HF-scavenging membranes, and moisture-absorbing membranes comprising aramid microfibers and aramid nanofibers. Also provided are rapid methods of preparing nanoporous separator membranes and moisture-absorbing membranes. Batteries, battery systems and visual indicators comprising a membrane of the application and are provided.

### CROSS-REFERENCE TO RELATED APPLICATION

This application claims priority to pending U.S. Provisional Patent Application No. 63/004,631, filed on Apr. 3, 2020, the entirety of which is herein incorporated by reference.

### FIELD OF THE DISCLOSURE

The present invention relates to moisture absorbing membranes comprising a blend of aramid microfibers and aramid nanofibers capable of absorbing a liquid equivalent to at least 1% of the GSM of the membrane, rapid methods for producing such a membrane, the use of such membranes in a battery, a rapid method of preparing a nanoporous separator membrane comprising aramid microfibers and aramid nanofibers, a hydrogen fluoride (HF) scavenging membrane, methods of decreasing moisture in a battery, methods of decreasing free HF in a battery, and a visual indicator of HF exposure.

### BACKGROUND OF THE PRIOR ART

Forms of Kevlar™ aramid-related fibers and ultra-strong fibers of various diameters exceeding a few 100 nm have been used to create membranes. See Zhang (2010) Applied Surface Science 256:2104-2109, Daido et al U.S. Pat. No. 6,291,106, and Zhang et al (2013) Solid State Ionics 245-246:49-55. Additionally, membranes and films comprising aramid nanofibers are known in the art. However, methods of preparing aramid nanofiber films or membranes are time consuming, often taking weeks.

Preparation of ANF-based ICMs and separators composites with the nanometer scale porosity required for ion-conduction and dendrite suppression can be accomplished following the layer-by-layer assembly (LBL or LbL) method. See Yang et al (2011) ACS Nano 5:6945-6954. LBL-made materials also display unparalleled uniformity, which is needed for elimination of the nanoscale “weak spots” facilitating dendrite growth. See Shim et al (2010) ACS Nano 4:3725-3734, Shim et al (2009) ACS Nano 3:1711-1722, Krogman et al (2007) Langmuir ACS J Surfaces Colloids 23:3137-3141, Jiang et al (2006) Advanced Materials 18:829-840. The ability of the technique to build up composite layers of micrometer thickness with large ionic content is conducive to high ion-conductance. However, LBL is based on deposition of a single nanometer-scaled layer at a time, and consequently requires non-traditional manufacturing equipment, and can be slow in implementation. It is non-obvious that other methods utilizing ANFs can give similar performance across multiple parameters required for ICMs and separators exemplified but not limited to stiffness, strength, pore size and distribution, ion conductance, thermal resilience, thickness variation.

Another major impediment to cost effective deployment of advanced lithium ion batteries (LIB) is the problem of capacity fading/reduced cycle lifetime. The electrolytes of conventional lithium ion batteries typically consist of a mixture of linear and cyclic organic carbonates and lithium hexafluorophosphate (LiPF₆). Even the purest grades of battery electrolytes typically contain about 25 ppm water, which without being limited by mechanism may be due to the hydroscopic properties of LiPF₆. The presence of water and moisture causes decomposition and subsequent formation of HF, which attacks and dissolves transition metals in a number of different cathode compositions. The presence of hydrofluoric acid (HF) in the liquid electrolyte has been identified as a major cause of this decomposition and reduced battery life. The dissolved metal ions migrate to and plate on the lithium/graphite anode, causing the lithium/graphite anode to fail. HF can also attack and leach out inorganic species (for example, LiF) deposited on cathode surface. If this takes place, the cathode surface, onto which LiF was once deposited, is now exposed to the electrolyte solution, and additional electrolyte decomposition occurs on the newly exposed surface. Several approaches have been used to improve the structural stability of cathodes in the presence of HF, including protective coatings, and utilization of basic additives in the electrolyte that chemically scavenge HF. Protective/reactive coatings have also been deposited on the separator. One drawback to all of these approaches is that they add mass and volume to the LIB without contributing to its capacity and/or power density. Further, battery decomposition is not readily detectable before the failure point of the battery. It is difficult to know when a battery has begun to deteriorate.

### SUMMARY OF THE DISCLOSURE

An embodiment of the application provides a rapid method of preparing a nanoporous separator membrane comprising aramid microfibers and aramid nanofibers comprising the steps of preparing a mixture of aramid pulp, dimethyl sulfoxide (DMSO) and potassium hydroxide, exposing the combination to high shear forces to form a slurry, preparing a mold with a layer of DMSO, adding the slurry to the mold, agitating the slurry and DMSO, applying a vacuum to the slurry in the mold, removing residual DMSO and drying the slurry to form a nanoporous separator membrane comprising aramid microfibers and aramid nanofibers. In an aspect, the ratio of aramid microfibers to aramid nanofibers ranges from 90:10, 80:20, 70:30, 50:50, 30:70, 20:80 to 10:90. In an aspect of the method, the aramid microfibers and aramid nanofibers are 0.1-2% of the slurry. In an aspect, the method yields a nanoporous separator membrane in less than 24 hours, less than 10 hours, less than 8 hours, less than 5 hours, or less than 3 hours. In an aspect, the step of exposing the combination to high shear force occurs for less than 2 hours, less than 1 hour, less than 30 minutes, less than 15 minutes, less than 10 minutes, or less than 5 minutes. In an aspect, the vacuum is applied at about 7-12 Hg. In aspects of the method, at least 10%, 20%, 30%, 40%, 50%, 60%, 70%, 80%, 90%, or 95% of the DMSO is removed from the slurry by the vacuum. In an aspect, the vacuum is applied for less than 5 minutes, less than 2 minutes, less than 1 minute, less than 50 seconds, less than 45 seconds, less than 40 seconds, less than 35 seconds, or less than 30 seconds. In aspects of the method, residual DMSO is removed with water. In aspects of the method, drying occurs at an elevated temperature. The elevated temperature may be in the range of 50°-100° C., 60°-90° C., 65°-80° C., or 65°-75° C. In various aspects of the methods, the mold is selected from the group of molds consisting of sheet molds, casting molds, mold and deckles, and cylinder molds.

In an embodiment, the application provides a hydrogen fluoride (HF)-scavenging membrane comprising aramid microfibers and aramid nanofibers wherein the separator changes color upon HF binding to the separator membrane.

In an embodiment, the application provides a moisture-absorbing membrane comprising aramid microfibers and aramid nanofibers wherein the membrane is capable of absorbing a liquid equivalent to at least 1% of the membrane mass. In an aspect, the nanofibers are produced by exposing aramid microfibers to a base in an aprotic solvent. In various aspects, the base is selected from the group of bases comprising Group I bases, Group II bases, sodium hydroxide, potassium hydroxide, lithium hydroxide, barium hydroxide, and magnesium hydroxide. In an aspect, the moisture-absorbing membrane further comprises at least one additive. The additive may be selected from the group comprising A1203. In an aspect of the membrane, the tensile strength of the membrane decreases dendrite growth. In an aspect, the tensile strength of the membrane is at least 35 MPa. In an aspect, the membrane exhibits an air permeability greater than 65 Gurley s. In an aspect, the membrane exhibits high ionic conductivity, as measured by the McMullin number, which is the ratio of the resistance of an electrolyte-filled separator to the resistance of the electrolyte alone. A McMullin number of less than 15, less than 12, less than 10, or even less than 8 indicates high ionic conductivity. In other aspects, the membrane's average pore size is less than or equal to d_{dendr}. In an aspect of the membrane, the membrane is capable of absorbing a liquid equivalent to at least 5%, 10%, 15%, 20%, 25%, 30%, 35%, 40%, 41%, 42%, 43%, 44%, 45%, 46%, 47%, 48%, 49%, 50%, 51%, 52%, 53%, 54%, 55%, or more of the membrane mass.

The application further provides a battery with increased moisture scavenging properties wherein the battery comprises a moisture-absorbing membrane of the application. In aspects, the battery exhibits decreased HF damage. In various aspects, a component of the battery is lined with the moisture-absorbing material. The component may be selected from the group of components comprising an anode, a cathode, and an encapsulating material. In an aspect, the battery comprises a nanoporous separator membrane comprising a moisture-absorbing membrane. In an aspect, the battery exhibits at least 90% capacity after 250 cycles.

The application provides a rapid method of preparing a moisture-absorbing membrane comprising the steps of preparing a mixture of aramid pulp, an aprotic solvent, and a base, exposing the mixture to high shear force to form a slurry comprising aramid microfibers and aramid nanofibers, preparing a mold with a layer of aprotic solvent, applying a vacuum, and drying at an elevated temperature to form a moisture-absorbing membrane comprising aramid microfibers and aramid nanofibers. In an aspect, the base is selected from the group comprising Group I bases, Group II bases, potassium hydroxide, sodium hydroxide, lithium hydroxide, barium hydroxide, magnesium hydroxide, and calcium hydroxide. In various aspects, the Group II base is selected from the group comprising barium hydroxide and calcium hydroxide. In an aspect, the moisture-absorbing membrane is prepared in less than 96 hours, less than 48 hours, less than 24 hours, less than 12 hours, less than 6 hours, or less than 3 hours. In an aspect, the aprotic solvent is DMSO. In various aspects, the elevated temperature is in the range of 50° C.-200° C., 60° C.-190° C., 75° C.-180° C., 85° C.-160° C., or 100°-160° C. In an aspect, the elevated temperature is equal to or above 180° C.

The application provides methods of decreasing moisture within a battery comprising incorporating a moisture-absorbing membrane of the application in the battery. The application provides methods of decreasing free HF in a battery comprising incorporating a moisture-absorbing membrane as described elsewhere herein.

The application provides a visual indicator of HF exposure comprising a moisture-absorbing membrane and a viewing aperture in which the moisture-absorbing membrane is disposed, wherein the membrane changes color upon HF binding to the moisture-absorbing membrane. In an aspect, the application provides a battery system comprising a visual indicator of HF exposure.

### INCORPORATION BY REFERENCE

All publications, patents, and patent applications mentioned in this specification are herein incorporated by reference in their entireties to the same extent as if each individual publication, patent, or patent application was specifically and individually indicated to be incorporated by reference.

### BRIEF DESCRIPTION OF THE DRAWINGS

FIGS. 1A and 1B provide photomicrographs of scanning electron microscopy images of aramid nanofibers from obtained from Dupont Kevlar Pulp Type 979A at (1A) 25000× and (1B) 2500× magnification.

FIGS. 2A and 2B provide graphs depicting a survey XPS spectra of a neat ANF separator only showing peaks of carbon (C), nitrogen (N), and oxygen (O) in panel A and a corresponding expansion of the carbon region, with C—C, C—N and C═O bonding peaks clearly visible in panel B.

FIGS. 3A and 3B provide graphs that show the corresponding XPS spectra of a similar ICM soaked in 1.2M LiPF₆ EC/EMC electrolyte overnight.

FIGS. 4A and 4B provide photographs of an aramid nanofiber membrane (panel A) and an aramid nanofiber membrane soaked in a 1.2M LiPF₆ EC/EMC electrolyte solution with 10.75 ppm HF (panel B).

FIG. 5A (panel A) depicts a plot of tensile strength (y-axis) vs pKb (x-axis) for moisture-absorbing membranes prepared with a variety of bases. FIG. 5B (panel B) depicts a plot of the air permeability of the membranes as measured in Gurley (s) vs vs pKb (x-axis) for moisture-absorbing membranes prepared with a variety of bases.

FIG. 6 summarizes data obtained from batteries comprising moisture absorbing membranes prepared with various bases after the indicated number of cycles (x-axis) and the percent capacity of the battery (y-axis).

FIG. 7 is a graphical representation that summarizes moisture uptake data obtained from moisture absorbing membranes prepared with the indicated base.

### DETAILED DESCRIPTION OF PREFERRED EMBODIMENTS AND THE DRAWINGS

Unless defined otherwise, all technical and scientific terms used herein have the meaning commonly understood by a person skilled in the art to which this invention belongs.

“A”, “an”, and “the”, as used herein, can include plural referents unless expressly and unequivocally limited to one referent.

Rapid methods of preparing a nanoporous separator membrane comprising aramid microfibers and nanofibers, HF-scavenging membranes, moisture-absorbing membranes capable of absorbing a liquid equivalent to at least 1% of the membrane mass, and rapid methods of preparing a moisture absorbing membrane are provided.

The term “membrane” is intended to include a film, sheet, laminate, tissue or planar flexible solid. Membrane characteristics include, but are not limited to, thickness, strength, pliability, tensile strength, porosity, and other characteristics. It is recognized that different membranes or different types of membranes may exhibit different or similar characteristics.

Nanoporous separator membranes are known in the art. Nanoporous membranes encompass a wide range of inorganic, organic or composite materials. For liquid phase separation, various types of nanoporous materials have been developed. Porous materials are often distinguished based on pore size, size distribution, shape, and order. Nanoporous materials comprise pore sizes that allow small materials to pass through the membrane. In various embodiments the pore sizes allow materials smaller than 2 nm, 5 nm, 10 nm, 20 nm, 30 nm, 40 nm, 50 nm, 60 nm, 70 nm, 80 nm, 90 nm, 100 nm, 120 nm, 140 nm, 160 nm, 180 nm, 200 nm, 220 nm, 240 nm, 260 nm, 280 nm, 300 nm, 320 nm, 340 nm, 360 nm, 380 nm, 400 nm, 420 nm, 440 nm, 460 nm, 480 nm, or 500 nm to pass through the membrane. Nanoporous separator membranes resist or prevent passage of larger than nanopore size molecules through the membrane.

The terms “ion conducting membrane” or “ICM” are intended to relate to a separator between two electrodes, being an anode and a cathode, or being a positive electrode and a negative electrode. An ion-conducting membrane allows ion flow between two regions whilst dividing, separating, or partitioning two regions.

The term “moisture-absorbing membrane” is intended to include a membrane capable of absorbing, taking in, retaining, soaking, internalizing, or trapping a liquid. Liquids of interest include, but are not limited to, organic solutions, aqueous solutions, electrolyte solutions, hydrofluoric acid, HF, and carbonate-based electrolyte solutions. Typically, moisture absorption is described as mass absorbed per amount (mass) of membrane or as moisture uptake capacity (g liquid/g sample). A moisture-absorbing membrane of the current application is capable of absorbing liquid equivalent to at least 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80% or more of the membrane mass. It is recognized a moisture-absorbing membrane may generally retain its original dimensions upon absorbing moisture or may generally alter its original dimensions by up to 0.5%, 1%, 5%, 10%, 15%, 20%, 35%, 40%, 50%, 60%, 70%, 80%, 90%, 100% or more. It is also recognized the dimensional change may occur upon absorption of a threshold level of liquid.

Aramid fibers are known in the art. Aramid polymers are defined as those that contain aromatic groups and amide linkages in the backbone. Normally, the amide groups provide linkages between adjacent aromatic groups. In one aspect, an aramid polymer is characterized as one in which at least 85% of the amide groups in the backbone are directly attached to two aromatic groups, especially where the aromatic groups are phenyl groups.

Aramid fibers include, but are not limited to, para-aramid fibers, meta-aramid fibers and copolyimide fibers. The para-aramid fiber backbone consists of phenyl groups separated by amide linkages, wherein the amides link the phenyl groups in a para configuration. Para-aramid fibers are known in the art, and include but are not limited to, Kevlar®, Twaron™, a poly (para-phenylene terephthalamide), and PPTA. Although the synthesis is not limited to reacting the particular monomers, in a simple form, a PPTA can be understood as the reaction product of para-phenylene diamine and terephthaloyl dichloride. A meta-aramid can be understood as the product of para-phenylene diamine and isophthaloyl dichloride. Meta-aramid fibers are known in the art, and include, but are not limited to NomexTM. Copolyamide fibers have structures that result from polymerizing other aromatic diamines with terephthaloyl or isophthaloyl chlorides, alternatively in the presence of para-phenylene diamine. Aramid material for use in the methods and compositions can also be obtained from used bullet proof vests, tents, ropes, or other items containing Kevlar/aramid macroscale fibers, or from waste or scrap from the manufacture of the aramid materials.

Aramid microfibers are characterized by a diameter in the micrometer range. Diameters of aramid microfibers may be in the range of 1 μ-500 μ, 1 μ-400 μ, 1 μ-300 μ, 1 μ-200 μ, 2 μ-150 μ, 3 μ-140 μ, 4 μ-130 μ, 5 μ-120 μ, 6 μ-110 μ, 7 μ-110 μ, 8 μ-110 μ, 9 μ-110 μ, 10 μ-110 μ, 20 μ-110 μ, 30 μ-110 μ, 40 μ-100 μ, and 50 μ-90 μ. Generally, aramid microfibers are characterized by a high aspect ratio, meaning the length of the microfibers is at least 5 times, at least 10 times or at least 20 times the diameter of the microfiber. It is recognized that aramid microfibers and aramid nanofibers may comprise branches.

By aramid nanofibers (ANF) is meant that the diameter of the aramid fiber is in the nanometer range, and especially in the range of 3 to 100 nanometers, 3 to 50 nanometers, 4 to 40 nanometers, 3 to 30 nanometers, and 3 to 20 nanometers. In addition to diameters in the nanometer range, the ANFs are characterized by a high aspect ratio, meaning that the length of the fibers is at least 5 times, at least 10 times, or at least 20 times the diameter. In various embodiments, the length of the ANFs is greater than 0.1 microns or greater than 1 micron. Without being limited by mechanism, aramid nanofibers may be produced by exposing aramid microfibers to a base in an aprotic solvent.

Such aramid membranes are disclosed herein may be provided solely with such aramid constituents. Alternatively, other synthetic fibers may be provided within such membranes, having the same or similar microfiber and nanofibers diameters to provide other potential characteristics. Such aramid fibers thus may be supplemented within a membrane structure with various types of polymeric fibers, including, without limitation, cellulose, polyacrylonitriles, polyolefins, polyolefin copolymers, polyamides, polyvinyl alcohol, polyethylene terephthalate, polybutylene terephthalate, polysulfone, polyvinyl fluoride, polyvinylidene fluoride, polyvinylidene fluoride-hexafluoropropylene, polymethyl pentene, polyphenylene sulfide, polyacetyl, polyurethane, aromatic polyamide, semi-aromatic polyamide, polypropylene terephthalate, polymethyl methacrylate, polystyrene, synthetic cellulosic polymers, and blends, mixtures and copolymers thereof. Such fibers may be provided as microfibers and nanofibers to form a single-layer structure (nonwoven) with the requisite aramid fibers present therein as well. Such structures may be formed according to the materials and methods disclosed within U.S. Pat. Nos. 8,936,878, 9,637,861, and 9,666,848, as examples. The aramid nanofibers thus contribute to the moisture absorption and HF scavenging capabilities of such combined polymeric fiber structures.

The ratio of aramid microfibers to aramid nanofibers in a membrane may range from 95:5, 90:10, 80:20, 70:30, 60:40, 50:50, 40:60, 30:70, 20:80, 10:90 or 5:95. In some embodiments higher nanofiber ratios are preferred.

Aramid pulp is a dry processed engineered low fibrillation, short aramid fibril. Aramid pulp is commercially available; any aramid pulp may be used in the methods.

Aprotic solvents are known in the art and include, but are not limited to, dimethylsulphoxide (DMSO) and N-methylpyrrolidone (NMP).

Bases for use in the methods include, but are not limited to, Group I bases and Group II bases such as sodium hydroxide, potassium hydroxide (KOH), lithium hydroxide, calcium hydroxide, barium hydroxide, and magnesium hydroxide. In some methods, the preferred base is KOH. In other methods, the preferred base is a Group II base. Surprisingly, moisture-absorbing membranes differ in their liquid absorption capacity depending upon the base with which the moisture-absorbing membrane was prepared. Preferred bases for preparing a moisture-absorbing membrane include, but are not limited to, Class II bases. Particularly preferred bases for preparing a moisture absorbing membrane include barium hydroxide and calcium hydroxide.

Rapid methods of preparing a nanoporous separator membrane comprise the step of preparing a combination of aramid pulp, dimethyl sulfoxide and potassium hydroxide. Generally aramid pulp and the aprotic solvent are combined in the range of 1000 ml solvent per 2.5 g pulp, 750 ml solvent per 2.5 g pulp, 500 ml solvent per 2.5 g pulp, 500 ml solvent per 2.5 g pulp, and 125 ml solvent per 2.5 g pulp, preferably in the range of 250 mL solvent per 2.5 g of pulp. Further it is recognized that additional aprotic solvent may be added to the combination, further diluting the solvent to pulp ratio. Proportions of aramid pulp, dimethyl sulfoxide and potassium hydroxide suitable for preparing aramid nanofiber membranes are known in the art. See for example U.S. Pat. No. 10,160,833, U.S. patent application Ser. Nos. 13/120,301, and 16/067,498. The pulp to KOH ratio may ranges from 1:2 to 1:100, 1:4 to 1:50, 1:6 to 1:25, and preferably 1:8 to 1:12.

Rapid methods of preparing a moisture absorbing membrane comprise the step of preparing a combination of aramid pulp, an aprotic solvent, and a base. Generally, aramid pulp and the aprotic solvent are combined in the range of 1000 ml solvent per 2.5 g pulp, 750 ml solvent per 2.5 g pulp, 500 ml solvent per 2.5 g pulp, 500 ml solvent per 2.5 g pulp, and 125 ml solvent per 2.5 g pulp, and preferably in the range of 250 mL solvent per 2.5 g of pulp. Further it is recognized that additional aprotic solvent may be added to the combination, further diluting the solvent to pulp ratio. The base may be selected from the group of bases comprising Group I bases, Group II bases, sodium hydroxide, potassium hydroxide, lithium hydroxide, barium hydroxide, calcium hydroxide, and magnesium hydroxide. In some embodiments, a Group II base selected from the group comprising barium hydroxide and calcium hydroxide is used. Surprisingly, varying the base results in moisture-absorbing membranes capable of absorbing different amounts of liquid. Generally, the amount of base to solvent ranges from approximately 10 mg base/L solvent, 0.5 mg base/L solvent, 1 mg base/L solvent, 10 mg base/L solvent, 100 mg base/L solvent, 200 mg base/L solvent, 300 mg base/L solvent, 400 mg base/L solvent, 500 mg base/L solvent, 600 mg base/L solvent, 700 mg base/L solvent, 800 mg base/L solvent, 900 mg base/L solvent, 1000 mg base/L solvent, 1.1 g base/L solvent, 1.2 g base/L solvent, to approximately 1.3 g base/L solvent.

The methods of preparing a membrane comprise the step of preparing a combination of aramid pulp, aprotic solvent, and a base. In some methods a combination of aramid pulp, DMSO, and KOH is prepared in a vessel. The combination is exposed to a high shear force to form a slurry. Methods of exposing a mixture to high shear force are known in the art and include, but are not limited to, mixing with a high-shear mixer. High-shear mixers are high-speed machines that offer homogenization, emulsification, disintegration, particle size reduction, and dispersion for many different solid and liquid materials. While not being limited by any specific mechanism, the materials undergo shear when one section of the material is imparted with a different velocity through use of a rotating impeller or high-speed rotor. The speed of the materials at the tip of the rotor may differ from the speed at the center, creating shear. High-shear mixers are able to combine solids and liquids that usually are unable to mix. Suitable high-shear mixers include, but are not limited to, high-shear batch mixers, inline high-shear mixers, ultrahigh-shear inline mixers, and laboratory high-shear mixers.

Exposing the combination to high-shear force may be for a duration or occur for less than 5 hours, 4 hours, 3 hours, 2 hours, 1 hour, 30 minutes, 15 minutes, 10 minutes, or less than 5 minutes. The duration of exposure to high shear force may be determined by factors such as, but not limited to, total volume, vessel shape, vessel size, initial pulp volume, initial pulp consistency, and the base. Methods of determining the appropriate duration of high-shear force exposure are known in the art.

An aramid fiber suspension or slurry typically ranges between 0.05-25% fiber content, 0.1%-20% fiber content, 0.1%-15% fiber content, 0.1%-10% fiber content, 0.1%-8% fiber content, 0.1%-6% fiber content, 0.1%-4% fiber content, and preferably 0.1-2% fiber content. It is recognized that the slurry content for creating the nanofibers may vary from the slurry content for sheet making. It is understood the fiber slurry for sheet making may be lower than or more dilute than the fiber slurry for making the nanofibers. In an aspect, the initial aramid fiber slurry is approximately a 1% fiber slurry while the fiber slurry for sheet making is approximately 0.125% for sheet making.

In aspects of the methods, a mold may be prepared with a layer of aprotic solvent such as DMSO. The slurry may be added to the mold. It is recognized that in some embodiments it may be preferred to add the slurry in such a way as to minimize or reduce turbulence. In other embodiments, the technique used to add the slurry may result in turbulence, bubbles, or air pockets. Molds for forming membranes, sheets, or films are known in the art. Any mold suitable for membrane formation may be used in the methods. Suitable molds include, but are not limited to, sheet molds, casting molds, mold and deckles, and cylinder molds.

Rapid methods of preparing a nanoporous separator membrane or a moisture-absorbing membrane comprise the step of agitating the slurry in the presence of an aprotic solvent. Methods of agitating the slurry and aprotic solvent are known in the art and include, but are not limited to, stirring, shaking, vibrating, spinning, and tumbling. In some aspects of the methods, additional aprotic solvent is added to the slurry.

Various methods comprise the step of applying a vacuum. Methods of applying a vacuum are known in the art. The vacuum may be applied in the range of about 1-50 Hg, 2-40 Hg, 3-30 Hg, 4-20 Hg, 5-15 Hg, 6-14 Hg, 7-13 Hg, and 7-12 Hg. The vacuum may remove at least 10%, 20%, 30%, 40%, 50%, 60%, 70%, 80%, 90%, 95%, 96%, 97%, 98%, 99% or 100% of the aprotic solvent. The vacuum may be applied for any desired duration. The vacuum may be applied for less than an 1 hour, 30 minutes, 15 minutes, 10 minutes, 5 minutes, 2 minutes, 1 minute, 55 seconds, 50 seconds, 45 seconds, 40 seconds, 35 seconds, or less than 30 seconds.

The methods may comprise the step of removing residual aprotic solvent. In some aspects, the residual aprotic solvent may be removed with water.

Rapid methods of preparing membranes may involve the step of drying the slurry to form a membrane comprising aramid microfibers and aramid nanofibers. Drying methods are known in the art. Drying may occur at an elevated temperature. An elevated temperature for a nanoporous separator membrane may be in the range of 50° C.-100° C., 60° C.-90° C., 65° C.-80° C., or 65° C.-75° C. Elevated temperatures for a moisture absorbing membrane may be equal to or above temperatures selected from group comprising 50° C., 60° C., 65° C., 70° C., 75° C., 80° C., 90° C., 100° C., 110° C., 120° C., 130° C., 140° C., 150° C., 160° C., 170° C., 180° C., 190° C., 200° C., 210° C., and 220° C. The elevated temperature for a moisture absorbing membrane may be in the range of 50° C.-100° C., 60° C.-90° C., 65° C.-80° C., or 65° C.-75° C.

A rapid method of preparing a membrane comprising aramid microfibers and aramid nanofibers may yield a membrane in less than 24 hours, less than 12 hours, less than 10 hours, less than 8 hours, or less than 3 hours. It is recognized that a rapid method of preparing a nanoporous separator membrane may yield a nanoporous separator membrane in a similar or different time frame than a rapid method of preparing a moisture absorbing membrane may yield a moisture absorbing membrane.

Hydrogen fluoride, HF, and the aqueous form of hydrogen fluoride (hydrofluoric acid) are highly corrosive compounds. HF corrosion is a problem particularly associated with batteries containing lithium, lithium hexafluorophosphate, or other lithium salts containing fluorine. This application provides an HF-scavenging membrane comprising aramid microfibers and aramid nanofibers. The term “HF-scavenging membrane” is intended to relate to a membrane that scavenges, binds, traps, ties, reacts, secures, or confines HF. The HF in the HF-scavenging membrane is less able to damage components than free HF. In some embodiments, an HF-scavenging membrane increases battery life. An HF-scavenging membrane comprising aramid microfibers and aramid nanofibers changes color upon HF binding to the membrane. Prior to binding HF, the membranes may exhibit a yellow hue or any shade of yellow. Upon binding to HF, the membrane undergoes a color change from its original color to pink, red, or a shade of pink. The color change is a visual indication of exposure to and binding of HF by the membrane. A change in color may indicate the need to replace a battery or battery component.

Moisture-absorbing membranes of the present application may further comprise one or more additives, including but not limited to A1203. Additives may increase moisture absorption, increase strength or change other characteristics of the moisture absorbing membrane.

Many of the safety problems of modern batteries are related to dendrite growth and anode expansion in the charged state. Piercing of porous polymer separators, for instance Celgard™ 2400, by dendrites is the most common mechanism of spontaneous battery failure which can also lead to short circuit and fire. The growth of dendrites is also the key roadblock for the development of batteries with lithium metal anodes, which can approach the theoretical limit for lithium-based storage devices with respect to capacity, power, and weight. The dendrites propagate through membranes via the path of the least mechanical resistance. The growth zones of dendrites, d_{dendr}, are 50-100 nm in size. If a heterogeneous separator material has soft pores larger than d_{dendr}, the parts with low modulus determine the propagation of dendrites rather than the stiffer parts. If the heterogeneity of an ICM is smaller than d_{dendr}, the growth zone of the dendrite experiences a resistance equal to the averaged modulus of the membrane. Many different approaches are used to prevent dendrite formation, including additives to the gel and liquid electrolyte, composite gel electrolytes with inorganic fillers, ANF-PEO, or ANF-PAO membranes (see U.S. application Ser. No. 15/120,301, as examples thereof). Moisture-absorbing membranes provided herein may have an average pore size less than or equal to d_{dendr}. Various moisture-absorbing membranes of the application decrease dendrite growth. By “decrease dendrite growth” is intended a decrease in the rate of dendrite growth, an absolute decrease in dendrite growth, and a decrease in dendrite growth in a particular time frame relative to dendrite growth in the absence of a claimed moisture absorbing membrane.

Moisture-absorbing membranes that exhibit high ionic conductivity are provided. The term “high ionic conductivity” is intended to relate to ionic conductivity above 0.01 mS/cm, 0.05 mS/cm, 0.1 mS/cm, 0.5 mS/cm, 1 mS/cm, 5 mS/cm, 10 mS/cm, 15 mS/cm, 20 mS/cm, 25 mS/cm, 30 mS/cm, 35 mS/cm, 40 mS/cm, 45 mS/cm, 50 mS/cm, 55 mS/cm, 60 mS/cm, or 70 mS/cm.

A battery exhibiting increased moisture scavenging properties comprising a moisture-absorbing membrane is provided. A battery as provided may exhibit decreased HF damage. The term “decreased HF damage” is intended to relate to reducing, lowering, and/or improving HF related damage to one or more battery component(s), reduced or lowered HF related damage during a period of time, or an extended period with medium to high capacity as compared to a battery without a moisture-absorbing membrane. A battery with increased moisture-scavenging properties may comprise a component lined with a moisture-absorbing membrane comprising aramid microfibers and aramid nanofibers. The component may be selected from the group of components comprising an anode, a cathode, an encapsulating material, and an ion conducting membrane. The term “encapsulating material” is intended to relate to any structure or device surrounding an anode, cathode, and electrolyte, such as, but not limited to, a wall, lid, top, floor, can, or canister. A battery comprising a moisture-absorbing membrane comprising aramid microfibers and aramid nanofibers may exhibit at least 90% capacity after 100 cycles, 150 cycles, 200 cycles, 250 cycles, 300 cycles, 350 cycles, 400 cycles, or more. A battery comprising a moisture-absorbing membrane comprising aramid microfibers and aramid nanofibers may exhibit at least 70% capacity after 50 cycles, after 60 cycles, after 70 cycles, after 80 cycles, after 90 cycles, after 100 cycles, 150 cycles, 200 cycles, 250 cycles, 300 cycles, 350 cycles, 400 cycles, 450 cycles, 500 cycles, or more.

Methods of decreasing moisture in a battery are provided. The methods comprise incorporating a moisture-absorbing membrane comprising aramid microfibers and aramid nanofibers in the battery. Methods of decreasing free HF in a battery are provided. The methods comprise incorporating a moisture-absorbing membrane comprising aramid microfibers and aramid nanofibers in the battery.

Also provided is a visual indicator of HF exposure comprising a moisture-absorbing membrane comprising aramid microfibers and aramid nanofibers and a viewing aperture. The moisture-absorbing membrane is disposed within the viewing aperture. The moisture-absorbing membrane changes color upon HF binding to the membrane. The color change indicates HF binding and HF exposure. It is recognized that the color change may be detected by a person or a device. A battery system comprising a visual indicator of HF exposure is also provided.

It will be understood that the reference to the below examples is for illustration purposes only and do not limit the scope of the claims.

### EXAMPLES

### Example 1. Preparing a Nanoporous Separator (Long Form)

The process encompasses the extended (1-5 weeks) digestions of aramid pulp exemplified but not limited to Dupont Kevlar Pulp Type 979A MERGE 1F1710 in dimethylsulfoxide (DMSO) with specific weight ratio of Kevlar pulp to added KOH. The pulp-KOH mass ratios are exemplified but not limited to 1:8 to 1:12. ANFs prepared using this protocol were processed into sheets with the thickness of 2-100 microns by filtration, spraying, casting, doctor blading, and painting followed by rinsing with water and drying.

The dried ANF-based sheets were separated from the microporous substrate. Suitable microporous substrates include, but are not limited to Millipore Mitex PTFE membrane filter, Omnipore PTFE membrane filter, Sterlitech PTFE membrane membrane filter, and Sumitomo Electric Poreflon PTFE membrane filter.

The nanoparticle separator comprising aramid nanofibers produced by the described method reveal pore size of 5 nm-150 nm, a tensile strength of 10 MPa-200 MPa, and Gurley number of 30-500.

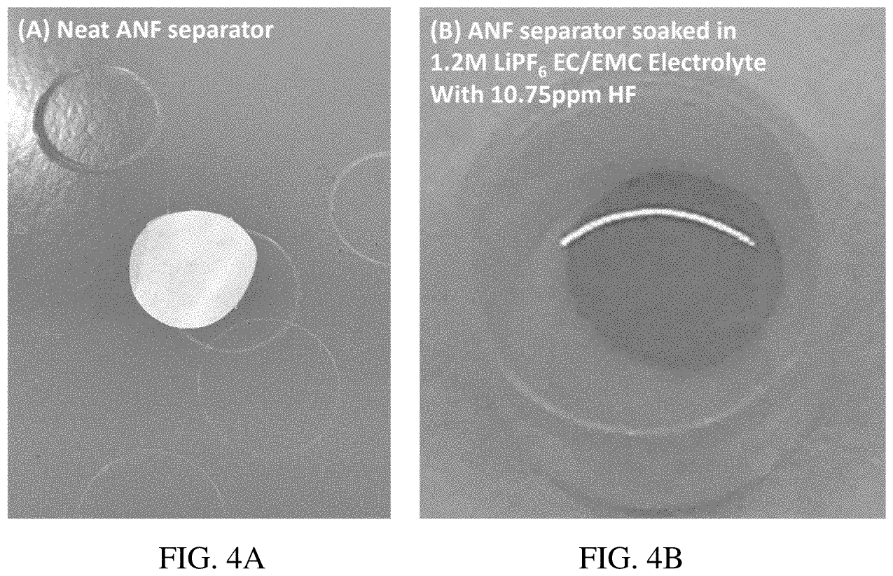

The nanoporous separators were incorporated in batteries. The separators from digested ANF display ability to sense the breakdown of electrolytes used in the batteries by changing color from light yellow to pink upon exposure to electrolytes that experienced aging. Results from one such experiment are shown in FIGS. 4A and 4B. Note the dark coloration of the membrane exposed to the 1.2M LiPF₆ EC/EMC Electrolyte solution in FIG. 4B (FIG. 4, panel B). The ANF separator develops a reddish coloration upon HF binding.

### Example 2. Rapid Process of Preparing a Nanoporous Separator Membrane

Kevlar pulp (5 g) was combined with 500 mL DMSO and 0.5 KOH powder. The mixture was exposed to high shear force mixing for 30 minutes to 6 hours at 6000-8000 rpm with a Silverson High-Shear Lab mixer to generate a slurry. Typically, the slurry contained 0.1%-2% fiber suspension. The slurry color progressed from cream to yellow to orange. In some experiments, the temperature reached 55° C. in the first 30 minutes. The slurry was diluted by the addition of 500 ml DMSO and mixed for 2 minutes. One liter of DMSO was then added. The diluted mixture was stirred at approximately 700 rpm for at least 2 hours.

A sheet mold with a 400 mesh 316 L stainless steel mesh used as the forming wire was prepared with KOH. A thin layer of DMSO was pumped onto the surface of the forming. The DMSO layer suspends the aramid nanofiber slurry and helps with uniformity. The aramid nanofiber slurry was pumped into the sheet mold. The slurry and DMSO were mixed with an electric drill with a propeller to achieve a predominantly uniform mixture. A vacuum (approximately 10 Hg) was applied to the sheet mold for approximately 2 minutes, removing the DMSO. In some experiments the vacuum was applied for 40-50 seconds. The sample was then washed with water. Without being limited by mechanism, the water removed excess DMSO and strengthens the sample. The sample was then transferred to an oven for drying at 70° C. for approximately 2 hours. After drying the sample can be easily peeled. After drying the samples were cut into 3″×12″ strips and fed into a calendar to achieve desired thickness. Nanoporous separator membrane samples were usually 12-16 gsm and 12-16 μm.

### Example 3. HF Binding to Nanoporous Separator Membrane

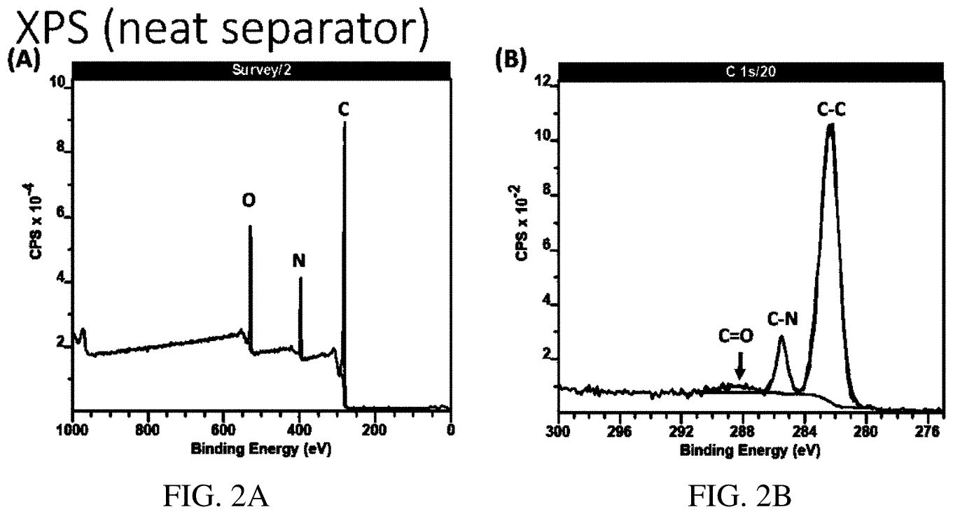

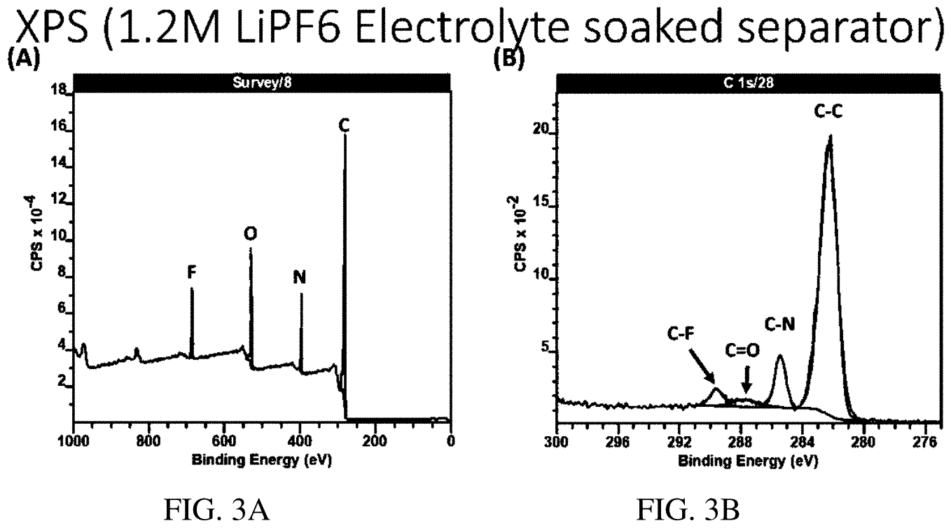

Nanoporous separator membranes were incubated with a control solution or to a 1.2M LiPF₆ EC/EMC electrolyte solution with 10.75 ppm HF. After incubation, the membranes were visually inspected. Membranes soaked with 1.2M LiPF₆ EC/EMC electrolyte solution with 10.75 ppm HF were pink or reddish, while membranes soaked in the control solution remained yellowish. Results from one such experiment are presented in FIG. 4. Samples of the nanoporous separator membrane were examined by XPS, and spectra from one such experiment are presented in FIG. 2. Samples of the 1.2M LiPF₆ EC/EMC soaked separator were examined by XPS, and spectra from one such experiment are presented in FIGS. 3A and 3B. The survey spectrum in FIG. 3A shows the addition of fluorine (F) at about 4 atom % to the sample, compared to that of the plain aramid nanofiber ICM. Additionally, the expansion of the carbon region in FIG. 3B further reveals that the added fluorine is bonded to carbon with the emergence of a peak due to the C—F bond. cl Example 4. Scanning Electron Microscopy of Nanoporous Separator Membrane

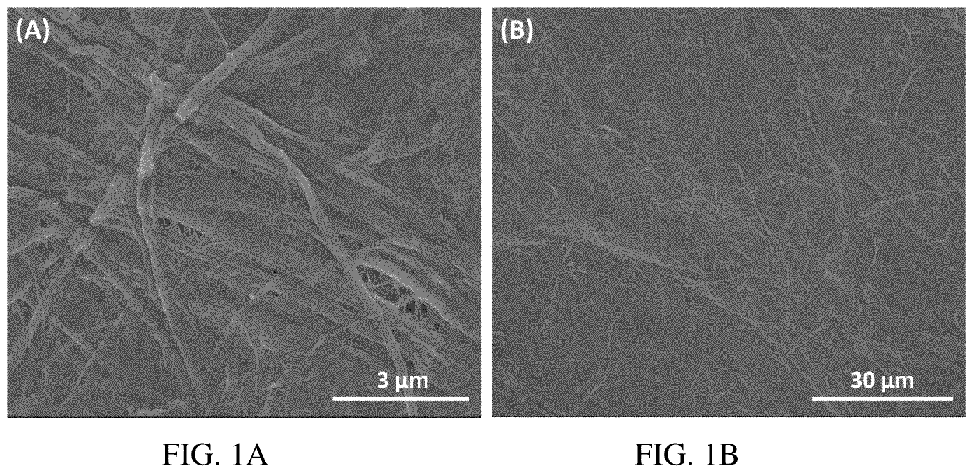

.The sample was cut and mounted onto a SEM sample holder using double sided carbon tape and sputter coated with gold. FIG. 1A was taken at 25000× magnification while FIG. 1B was taken at 2500× magnification.

### Example 5. Preparation of Moisture Absorbing Membranes

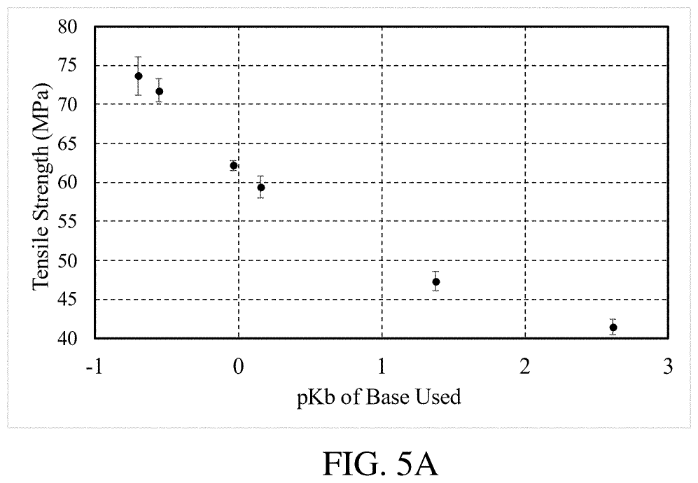

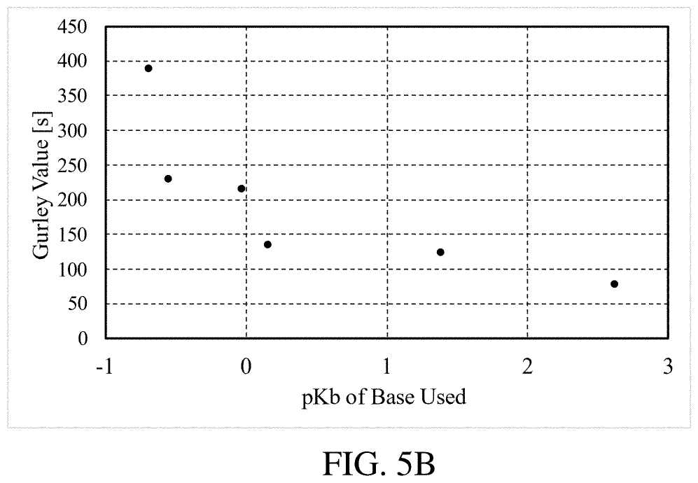

A moisture absorbing membrane comprising aramid microfibers and aramid nanofibers was prepared by combining Kevlar pulp with DMSO and various Group I or Group II bases including potassium hydroxide, sodium hydroxide, lithium hydroxide, barium hydroxide or calcium hydroxide. The mixture was combined with high shear force to form a slurry comprising aramid microfibers and aramid nanofibers. A mold was prepared with an aprotic solvent and the slurry was placed in the mold. The slurry was agitated in the mold, then a vacuum was applied. After the vacuum process, the sample was dried at 150-250° C. for two hours. The tensile strength, stiffness, and air permeability of each membrane was evaluated. Results from one such series of experiments are shown in FIG. 5 and summarized in Table 1, below (wherein air permeability is a function of porosity). The underlying data measured in this respect is as follows:

TABLE 1
Characteristics of Moisture-Absorbing
Membranes Prepared with Various Bases

| | Basicity | Tensile | | Gurley |
|---|---|---|---|---|
| Base | (pKb) | (MPa) | St. Dev | (s) |
| Potassium Hydroxide | −0.7 | 73.3381923 | 2.466957 | 389 |
| Sodium Hydroxide | −0.56 | 71.40520782 | 1.794529 | 230 |
| Lithium Hydroxide | −0.04 | 61.97811423 | 0.619596 | 214 |
| Barium Hydroxide | 0.15 | 59.21306745 | 1.370441 | 136 |
| Calcium Hydroxide | 1.37 | 47.21359564 | 1.285486 | 125 |
| Magnesium Hydroxide | 2.6 | 41.42226878 | 1.074236 | 78 |

### Example 6. Capacity Evaluation

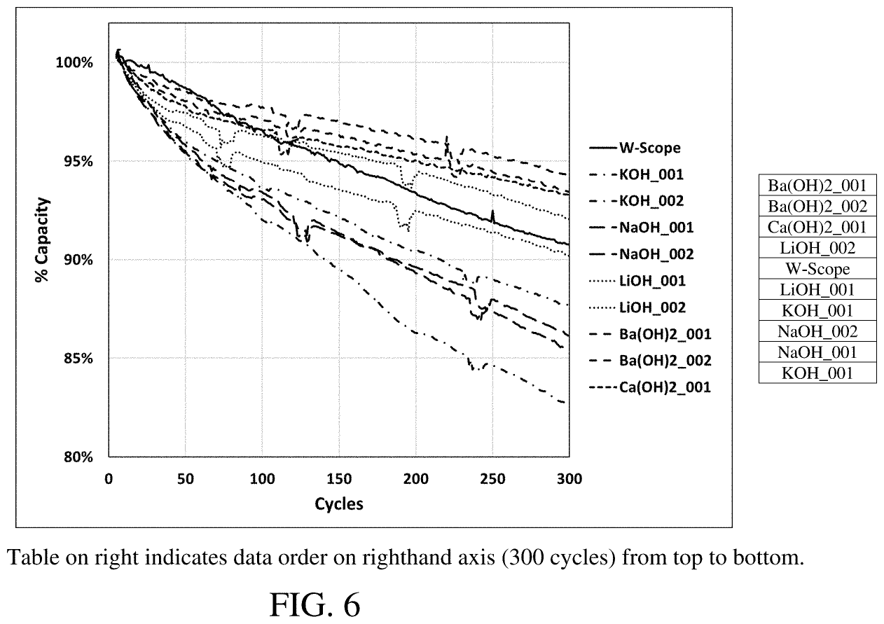

Moisture absorbing membranes were prepared using various bases as described above. Lithium ion batteries comprising the moisture absorbing membranes as ion conducting membranes were prepared. A 1.2M LiPF₆ EC/EMC electrolyte solution was used in the batteries. The batteries were subjected to multiple cycles. The remaining percent capacity was evaluated after cycle 50, 100, 150, 200, 250, and 300. The results from one such experiment are presented in FIG. 6. As noted therein, batteries with membranes prepared with barium hydroxide and calcium hydroxide remained above 90% capacity at 150, 200, 250, and 300 cycles. Batteries with membranes prepared with sodium hydroxide dropped below 90% capacity by 200 cycles. Batteries with membranes prepared with potassium hydroxide show variable results with at least one dropping below 90% capacity by 150 cycles.

### Example 7. Moisture Uptake Capacity

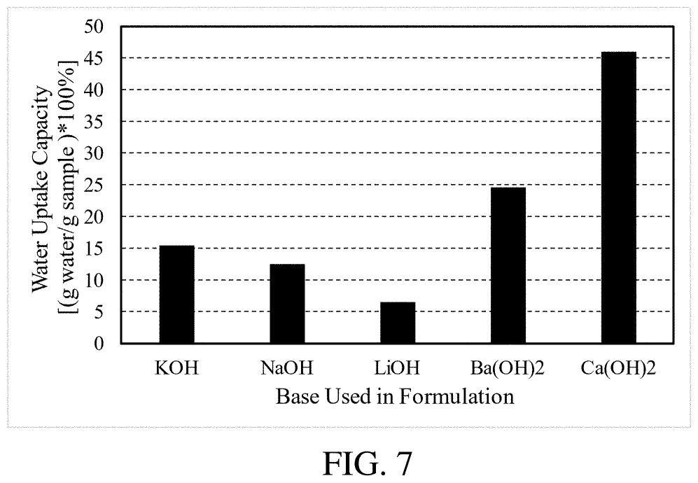

Moisture absorbing membranes were prepared by incubating aramid microfibers with potassium hydroxide, sodium hydroxide, lithium hydroxide, barium hydroxide or calcium hydroxide. Samples of each membrane were prepared. The mass of each membrane sample (g) was determined. Each membrane sample was incubated with a EC:DMC 1:1 w/w solution with 1000 ppm of water. The membrane samples were removed from the wet solvent. The mass of the absorbed water (g) was determined by measuring the amount of water remaining in the incubating solvent. Results from one such experiment are provided in Table 2 and shown in graphical format in FIG. 7. As shown therein, the percent moisture uptake capacity (g water/g membrane sample) is indicated on the y-axis. The base used to formulate each moisture absorbing membrane is indicated on the x-axis. In the particular experiment shown here, a membrane prepared with LiOH absorbed water equivalent to more than 5% of the membrane mass, a membrane prepared with NaOH absorbed water equivalent to more than 10% of the membrane mass, a membrane prepared with KOH absorbed water equivalent to more than 15% of the membrane mass, a membrane prepared with Ba(OH)₂ absorbed water equivalent to more than 20% of the membrane mass, and a membrane prepared with Ca(OH)₂ absorbed water equivalent to more than 45% of the membrane mass. These results are based upon measurements related to a number of different considerations, including 1) the weight of the membrane after being dried for 1 hour at 150° C., 2) the measured water concentration within the electrolyte after the membrane is soaked in 300 ml of electrolyte for 48 his (as measured by Karl Fischer titration). 3) the amount of water removed from the membrane as calculated from the water concentration of 2) and the amount of electrolyte (300 ml), where the amount is calculated as 300 ml*(water concentration−initial water concentration)/1000, where the initial water concentration is the amount of water in the electrolyte prior to soaking (˜2000 ppm), and 4) the amount of water removed, as a ratio of the weight of membrane. basically the measured result of 3)/[1000*the weight of 1)]. The tabular results are as follows:

TABLE 2
Characteristics of Moisture-Absorbing
Membranes Prepared with Various Bases

| | | Measured | Amount | |
|---|---|---|---|---|
| | Membrane | Water | of Water | Water |
| | Weight | Content | Removed | Capacity |
| Base | (g)(1) | (mL/g)(2) | (g)(3) | (%)(4) |
| Potassium Hydroxide | 0.1655 | 1823.8 | 26.22 | 16 |
| Sodium Hydroxide | 0.1764 | 1837.1 | 22.23 | 13 |
| Lithium Hydroxide | 0.1653 | 1875.0 | 10.86 | 7 |
| Barium Hydroxide | 0.1706 | 1772.4 | 41.64 | 24 |
| Calcium Hydroxide | 0.1687 | 1652.5 | 77.61 | 36 |
| Control (Solvent only) | −0.0015 | 1911.2 | | |

Such results and examples thus show significant potential for a number of beneficial characteristics within certain end uses utilizing such membranes comprising polyaramid microfibers and nanofibers. Moisture absorption and HF scavenging, as non-limiting examples, provide noticeable results that have heretofore been unavailable within the lithium ion, at least, battery industry.

That which is claimed:

1. A battery separator membrane structure comprising aramid microfibers and aramid nanofibers, wherein said membrane exhibits hydrogen fluoride scavenging capability.

2. The membrane structure of claim 1 wherein said membrane exhibits color change upon binding of hydrogen fluoride thereto.

3. A moisture-absorbing battery separator membrane comprising aramid microfibers and aramid nanofibers, wherein said membrane is capable of absorbing liquid equivalent to at least 1% of said membrane mass, when a ratio of 0.2 g of membrane is exposed to 300 ml of electrolyte comprising 1:1 ratio of EC:DMC and 2000 ppm of water for 48 hrs.

4. The moisture-absorbing battery separator membrane of claim 3 further comprising at least one additive.

5. The moisture-absorbing battery separator membrane of claim 4 wherein said additive is Al₂O₃.

6. The moisture-absorbing battery separator membrane of claim 3 wherein said membrane decreases dendrite growth.

7. The moisture-absorbing membrane of claim 3 wherein the tensile strength of said membrane is at least 35 MPa.

8. The moisture-absorbing battery separator membrane of claim 3 wherein said membrane exhibits an air permeability greater than 65 Gurley s.

9. The moisture-absorbing battery separator membrane of claim 3 wherein said membrane exhibits high ionic conductivity.

10. The moisture-absorbing battery separator membrane of claim 3 wherein said membrane's average pore size is less than or equal to d_{dendr}.

11. The moisture-absorbing battery separator membrane of claim 3 wherein said membrane is capable of absorbing a liquid equivalent from at least 5% to at least 45% of said membrane mass.

12. A battery comprising said moisture-absorbing battery separator membrane of claim 3.

13. The battery of claim 12 wherein said battery exhibits hydrogen fluoride scavenging properties.

14. The battery of claim 12 wherein a component of said battery has a surface adjacent to the surface of said moisture-absorbing battery separator membrane.

15. The battery of claim 14 wherein said component is selected from the group of components comprising an anode, cathode, and encapsulating material.

16. The battery of claim 13 wherein said battery comprises an ion-conducting membrane comprising said moisture-absorbing battery separator membrane.

17. The battery of claim 13, wherein said battery exhibits at least 90% capacity after 250 cycles.

18. A battery comprising said battery separator membrane structure of claim 1.

19. A method of decreasing mobile moisture in a battery, comprising incorporating a moisture absorbing membrane of claim 3 in said battery.

20. A method of decreasing free HF in a battery, comprising incorporating said moisture-absorbing membrane of claim 1 in said battery.

21. A visual indicator of HF exposure comprising said moisture-absorbing membrane of claim 1 and a viewing aperture in which said moisture-absorbing membrane is disposed wherein said membrane changes color upon HF binding to said moisture-absorbing membrane.

22. A battery system comprising said visual indicator of claim 21.
